(19) United States
(12) Patent Application Publication
(10) Pub. No.: US 2017/0147164 A1
(43) Pub. Date: May 25, 2017

(54) TOUCH HEAT MAP

(71) Applicant: GOOGLE INC., Mountain View, CA (US)

(72) Inventor: Alberto Martin PEREZ, Mountain View, CA (US)

(21) Appl. No.: 14/952,394

(22) Filed: Nov. 25, 2015

(51) Int. Cl. G06F 3/0482; G06F 3/0484; G06F 3/041

(52) U.S. Cl. CPC G06F 3/0482; G06F 3/0412; G06F 3/0416; G06F 3/04842

(57) ABSTRACT

A system and method for operating an electronic computing device may include accessing a touch heat map in response to receiving a touch input on a touch sensitive surface of a touchscreen display of the device. The touch heat map may include touch input data associated with touch inputs applied to a screen displayed by the touchscreen display device associated with an application. Touch input data collected in the touch heat map may be used to predict a selection associated with the touch input received on the touch sensitive surface.

### FIELD

This document relates, generally, to electronic devices that include a touch sensitive input surface.

### BACKGROUND

Electronic devices, in particular, portable electronic devices, may include a touch sensitive input device, or touchscreen. The touchscreen may display images, and may receive user touch inputs on its touch sensitive surface. A touch input received in a particular area of the touchscreen may correspond to, for example, an icon representing an application to be launched in response to the touch input, a link to be executed in response to the touch input, and the like. As capabilities associated with these types of electronic devices continue to expand, and more information in different formats is presented for selection on the touchscreen, ways to facilitate accurate user selection of items from the display on the touchscreen may enhance user convenience.

### SUMMARY

In one aspect, a method of operating an electronic computing device may include generating a touch heat map based on a plurality of touch inputs received on a touch sensitive surface of a touch sensitive device, the touch heat map being associated with an executable application of the touch sensitive device, and storing the touch heat map in a memory of the touch sensitive device, executing the application, accessing the stored touch heat map, receiving a first touch input on the touch sensitive surface of the touch sensitive device, and predicting a second touch input based on the first touch input and a touch input history provided by the touch heat map.

In another aspect, a method of operating an electronic computing device may include receiving, on a touch sensitive surface of a touchscreen display device, a first touch input, accessing, in response to the first touch input, a touch heat map, the touch heat map including touch input data corresponding to a user input interface associated with the received first touch input, predicting a user selection from a plurality of items available via the user input interface based on the touch input data included in the touch heat map.

In another aspect, an electronic computing device may include a display device including a touchscreen display having a touch sensitive surface, a memory storing executable instructions, and a processor configured to execute the instructions to cause the electronic computing device to generate a touch heat map based on a plurality of touch inputs received on the touch sensitive surface of the touchscreen display, the touch heat map being associated with an application executable by the device, to store the touch heat map in the memory, to execute the application in response to a first touch input on the touch sensitive surface of the touchscreen display, and to predict a second touch input based on the first touch input and a touch history provided by the touch heat map.

The details of one or more implementations are set forth in the accompanying drawings and the description below. Other features will be apparent from the description and drawings, and from the claims.

### BRIEF DESCRIPTION OF THE DRAWINGS

FIGS. 1A-1D illustrate various exemplary electronic computing devices, in accordance with implementations as described herein.

FIG. 2 is a block diagram of an exemplary electronic computing device, in accordance with implementations as described herein.

FIGS. 3A-3D illustrate selection of items from a sequence of display screen user interfaces, in accordance with implementations as described herein.

FIG. 4A illustrates an example touch heat map, and FIG. 4B illustrates a display screen user interface generated based on the touch heat map shown in FIG. 4A, in accordance with implementations as described herein.

FIGS. 5A-5C illustrate selection of items from a sequence of display screen user interfaces, in accordance with implementations as described herein.

FIG. 6 is a flowchart of a method of operating an electronic computing device, in accordance with implementations as described herein.

FIG. 7 illustrates an example of a computing device and a mobile computing device that can be used to implement the techniques described herein.

### DETAILED DESCRIPTION

Electronic computing devices, including, for example, laptop computers, notebook computers, tablet devices, smartphone devices, and other such devices, may include a touchscreen display device configured to both display information to a user, and also to receive user touch inputs through a touch sensitive surface of the touchscreen. Expanded use of these electronic devices to include accessing the Internet through, for example, a wired or wireless connection, pairing and exchanging information with other electronic devices, simultaneous execution of numerous applications, and the like, may increase an amount of information displayed to the user on the touchscreen, making accurate selection difficult on a display crowded with icons, links and the like available for selection through touch input by the user. For example, accurate selection of a single link from within multiple links sequentially displayed on a touchscreen may be difficult using a touch input, as the touch input may overlap multiple links adjacent to the link to be selected. This difficulty may be exacerbated by a device having a relatively small touchscreen area, such as a smartphone.

Some of these types of electronic devices may implement a zoom mode, in which the user may zoom in on a particular on a selected area using, for example, a pinch and zoom touch and drag input on the touchscreen, a zoom icon displayed on the touchscreen and the like. While zooming in on information displayed on the touchscreen in this manner does allow a user to apply a touch input to an intended link or item more easily, this type of zoom in also causes a certain amount of information, essentially proportional to the amount of zoom, to no longer be visible to the user without scrolling. Some of these types of electronic devices may allow a user to increase a font and/or icon display size, so that icons, links and the like may be more easily viewed on the touchscreen by the user. However, this increase in font/icon size may have a similar effect, in that a certain amount of information will no longer be visible to the user on the screen due to the increased font/icon size.

An electronic device, in accordance with implementations as described herein, may collect touch input information to generate heat map(s) of user interactions with different applications of the electronic device and associated user profile(s). The electronic device may then predict where a user may touch next while in a particular application based on the heat map and user profile. In some implementations, the electronic device may, for example, enlarge a particular icon or link based on this prediction, to make it easier for the user to select the icon or link, without enlarging other displayed items. This allows the other displayed items to remain displayed, in the event the user chooses to select an icon or link other than the icon or link that is enlarged based on the prediction. In some implementations, the electronic device may use the heat map and user profile to discriminate an ambiguous user touch input, i.e., a user touch input which extends across multiple possible selections displayed on the touchscreen and in which the user's intention may be ambiguous. In some implementations, the electronic device may collect additional touch input data and update the heat map(s) and user profiles using the additional touch input data, so that predictions based on the heat map(s) may be improved.

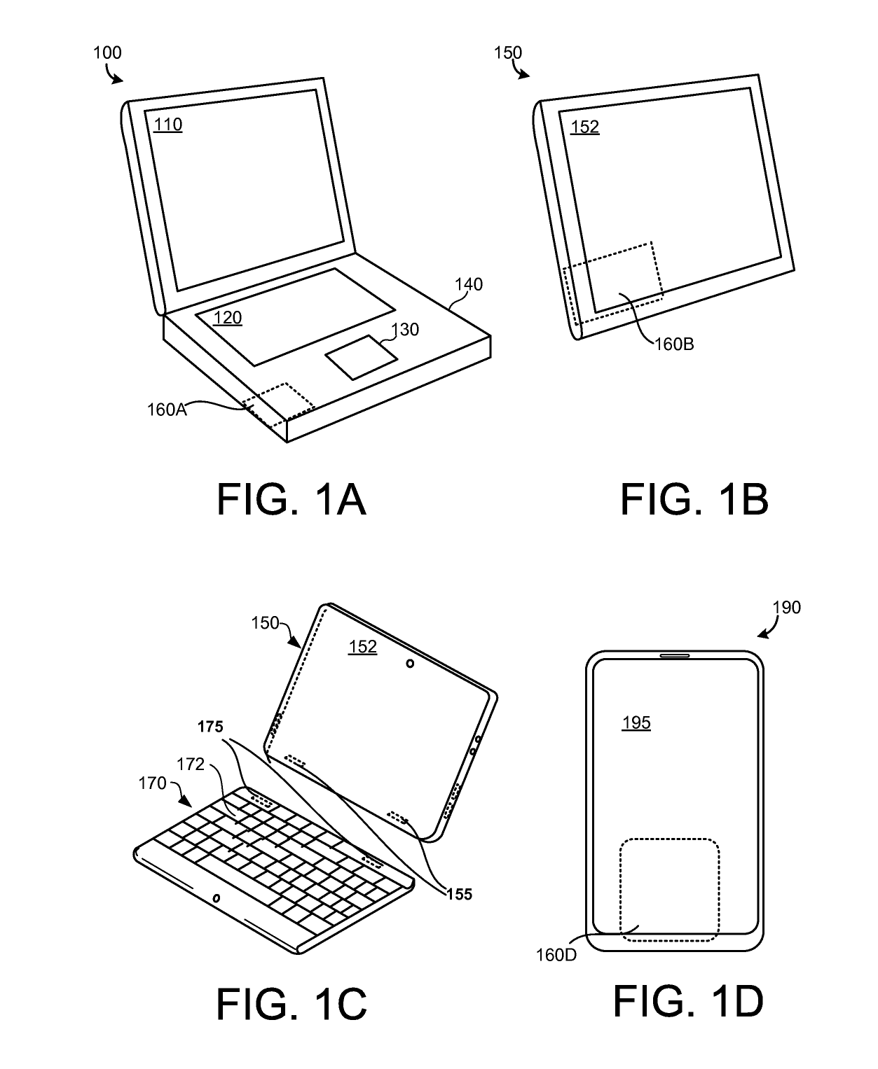

Various different types of exemplary electronic computing devices are shown in FIGS. 1A-1D. For example, FIG. 1A illustrates a laptop computing device 100 including a display 110 coupled to a base 140, the base 140 including various input devices such as, for example, a keyboard 120, a touch sensitive pad 130 and the like. The display 110 may be a touchscreen display device 110, providing an interface for both displaying information to the user and receiving touch inputs from the user. FIG. 1B illustrates a tablet computing device 150 configured without a keyboard, and with, for example, a touchscreen display 152 providing an interface for both displaying information to the user and receiving touch inputs from the user. In some implementations, the tablet computing device 150 shown in FIG. 1B may be selectively coupled with a base 170, or docking station 170, as shown in FIG. 1C. The base 170 may provide varied functionality, such as, for example, a keyboard 172 to provide for an alternative method of text entry. The base 170 may also facilitate charging through connection between power port(s) 155, or terminal(s) 155 of the tablet computing device 150 and power port(s) 175, or terminal(s) 175, of the base 170, and the like. FIG. 1D illustrates a smart phone computing device 190 including, for example, a touchscreen display 195 providing an interface for both displaying information to the user and receiving touch inputs from the user. Electronic devices, such as the exemplary computing devices 100, 150 and 190 shown in FIGS. 1A-1D, may include a power storage device, such as a battery 160A, 160B and 160D, respectively, storing power for use during operation when not connected to an external power source.

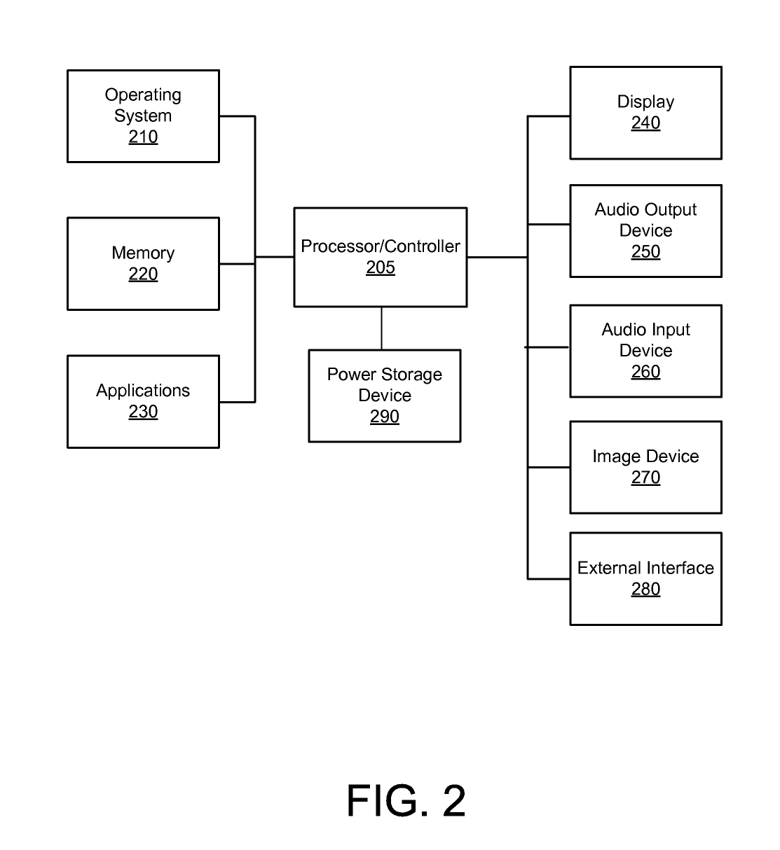

FIG. 2 is a block diagram of an example computing device, that may collect touch input information and generate touch heat maps and associated user profiles, in accordance with an implementation as described herein. In some implementations, the computing device 200 may include, for example, a processor/controller 205 invoking an operating system 210 and a memory 220 to run various applications 230. The computing device 200 may also include a display 240, which may be a touchscreen display device 240 capable of both displaying images to the user and receiving input in the form of touch inputs on a touch sensitive surface of the touchscreen display device 240, an audio output device 250 including, for example, a speaker and/or a headphone port, an audio input device 260 including, for example, a microphone, an image device 270 capturing still and/or moving images such as, for example, a camera or webcam, an interface device 280 including, for example a communication port and/or interface port such as, for example, one or more USB ports, HDMI ports and the like, and other such components. The computing device 200 may also include a power storage device 290, or battery 290.

In some implementations, the example computing device 200 may be configured to automatically collect touch input information received via the touchscreen display device 240, and to generate heat map(s) of user interactions with application(s) 230 of the computing device 200 and associated user profile(s). For example, a user profile AX may be generated based on a heat map M generated of user A's use of application X, and a user profile AY may be generated based on a heat map N of user A's use of application Y. This may allow the user A of the computing device 200 to have a personalized profile for each of the applications X and Y, and to predict user A's intended usage and selections of the individual applications X and Y, based on user A's own personal usage, and usage history, of that specific application. Similarly, for a second user B of the same computing device 200, a user profile BX may be generated based on a heat map R of user B's use of application X, and a user profile BY may be generated based on a heat map S of user B's use of application Y. This may allow multiple users (in this example, user A and user B) of the same computing device 200 to have personalized profiles for each of the applications based on the user's own personal usage, and usage history, of the particular application.

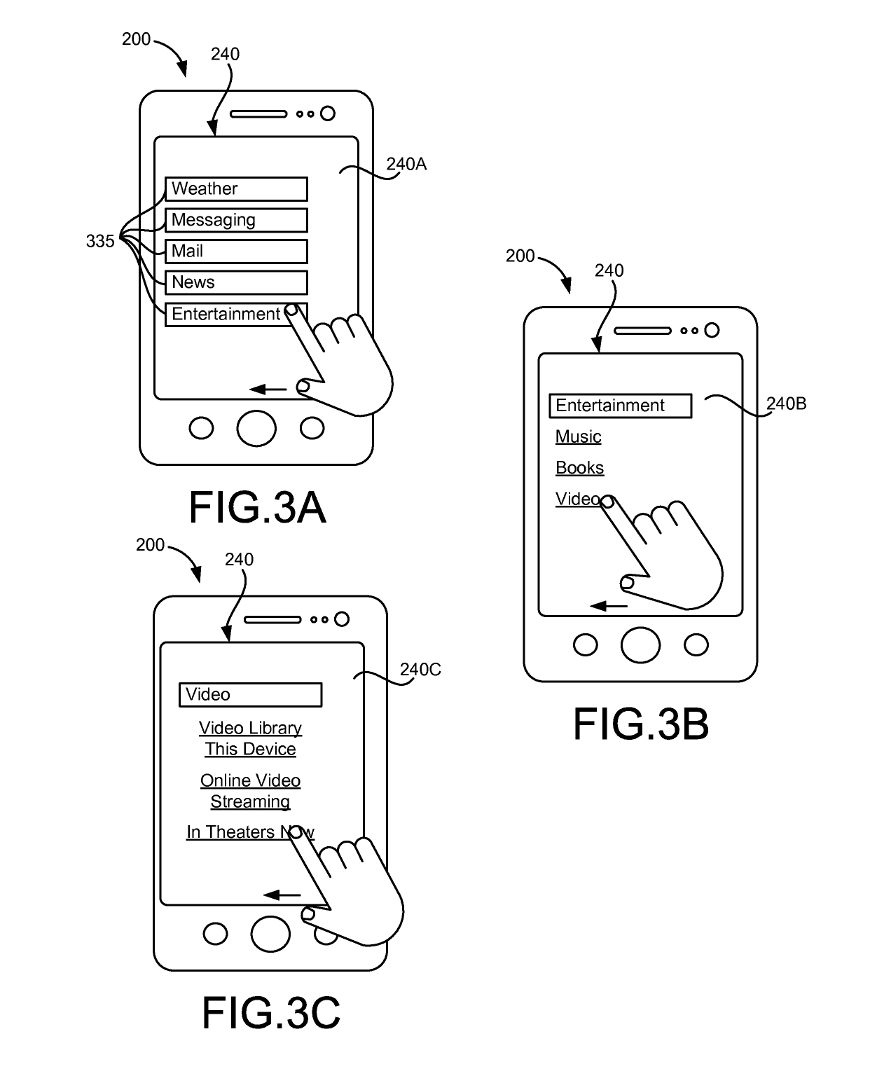

An example implementation of a mobile electronic computing device is shown in FIGS. 3A-3D. In FIGS. 3A-3D, the example mobile electronic computing device is illustrated as a smartphone, simply for ease of discussion and illustration of the implementation of touch heat map(s) and user profile(s) for touch prediction, in accordance with implementations described herein. However, the principles described herein may be applied to numerous other types of electronic computing devices having a touch sensitive surface, or touchscreen, configured to display items for selection and receive touch inputs for selection of the displayed items.

As shown in FIG. 3A, a plurality of items, for example, a plurality of icons 235 respectively representing a plurality of applications 230 available for selection and execution by the computing device 200, may be displayed on the display 240 of the device 200. The display 240 may be a touchscreen display 240 including a touch sensitive surface, such that the touchscreen display 240 is configured to display a screen 240A including, for example, the icons 235 representing applications 230 as shown in FIG. 3A, as well as to receive a user touch input selecting one of the icons 235 for execution of the corresponding application 230.

In response to a user touch input applied to one of the icons 235 shown in FIG. 3A, an Entertainment application 230 may be launched, and links to additional items available for selection, associated with the Entertainment application, may be displayed on a screen 240B by the touchscreen display 240, as shown in FIG. 3B. As the icons 235 are displayed on the screen 240A by the touchscreen display 240 and a selection is made by a particular user A from the currently displayed screen 240A, user A's touch input on the screen 240A may be stored, for example, in the memory 220, and collected in a touch heat map illustrating a history of user A's interaction with screen 240A, which may be used to predict future interaction of user A with screen 240A.

In response to a user touch input applied to the Video link associated with the Entertainment application from the screen 240B, as shown in FIG. 3B, links to additional items available for selection, associated with the Video component of the Entertainment application, are displayed on a screed 240C by the touchscreen display 240, as shown in FIG. 3C. As the links are displayed on the screen 240B by the touchscreen display 240 and a selection is made by the user A from the currently displayed screen 240B, user A's touch input on the screen 240B may be stored, for example, in the memory 220, and collected in a touch heat map illustrating a history of user A's interaction with screen 240B, which may be used to predict future interaction of user A with screen 240B.

In response to a user touch input applied to the In Theaters Now link associated with the Video component of the Entertainment application, as shown in FIG. 3C, links to additional items available for selection, associated with the In Theaters Now component, are displayed on the touchscreen display 240, as shown in FIG. 3D. As the links are displayed on the screen 240C by the touchscreen display 240 and a selection is made by the user A from the currently displayed screen 240C, user A's touch input on the screen 240C may be stored, for example, in the memory 220, and collected in a touch heat map illustrating a history of user A's interaction with screen 240C, which may be used to predict future interaction of user A with screen 240C.

In the example shown in FIG. 3D, a plurality of links are displayed on a screen 240D displayed by the touchscreen display 240, presenting links to different types of information available to the user, related to movies currently available for viewing in a movie theater. In the example shown in FIG. 3D, the user A applies a touch input to a Buy Tickets link, and user A's touch input on the screen 240D may be stored, for example, in the memory 220, and collected in a touch heat map illustrating a history of user A's interaction with screen 240D, which may be used to predict future interaction of user A with screen 240D, as discussed above.

In some implementations, the respective touch heat map for each of the screens 240A-240D 40 may be accessed, from, for example, the memory 220 by the processor 205 of the device 200, to predict a touch input area, or area of interest, or selection to be made, by the user A from the screen to be displayed. Based on this prediction, in some implementations, the device 200 may alter how the information is displayed on the respective screen 240A-240D, to facilitate user A's access to the information and/or selection of a particular link, based on user A's past interaction with a particular one of the screens 240A-240D.

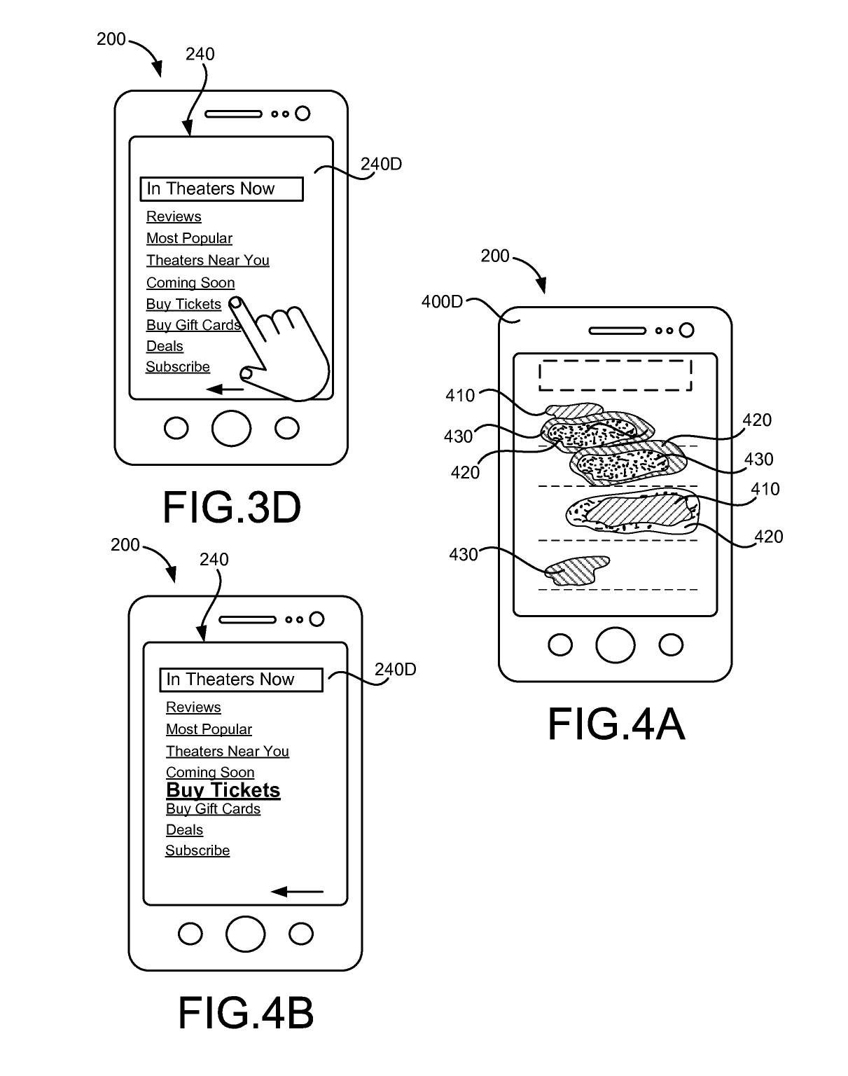

For example, in response to the user touch input on the screen 240C, applied to the In Theaters link, as shown in FIG. 3C, the controller 205 may access information collected in a touch heat map 400D, which may be stored in the memory 220, as shown in FIG. 4A, prior to displaying the screen 240D. The information collected in the example touch heat map 400D shown in FIG. 4A may correspond to user A's usage and interaction with screen 240D, associated with the In Theaters link. Based on the information accessed from the touch heat map 400D and processed by the controller 205, the device 200 may alter how the information is presented and displayed to user A on screen 240D.

For example, based on the touch input data represented in the touch heat map 400D, a first area 410 may be most an area of screen 240D receiving the most frequent touch inputs from user A. Based on this information determined from the touch heat map, the device 200 may alter an appearance of the information presented and displayed to the user A on screen 240D. In the example shown in FIG. 4B, the Buy Tickets link is enlarged, compared to the other links displayed on screen 240D, as, based on the information collected in the touch heat map 400D, user A most frequently selects the Buy Tickets link from screen 240D. This may facilitate the user's efficient and accurate interaction with the currently displayed screen 240D, allowing for easy selection of the Buy Tickets link. In particular, this arrangement provides for the automatic enlargement of only the Buy Tickets link (predicted, based on the data collected in the touch heat map). The automatic enlargement of only the Buy Tickets link can occur without requiring, for example, a pinch and zoom action by a user to zoom in on the portion of the screen that contains the But Tickets link. Rather, the automatic enlargement of only the Buy Tickets link can occur in conjunction with moving some of the remaining information off screen, such that scrolling in the display is necessary to access the other information or by reducing the displayed size of the other information. Prediction of a user's next selection, and enlargement of the predicted selection, may facilitate selection of the user's predicted selection, while allowing alternative selections to remain displayed and easily accessible, enhancing utility and functionality to the user.

In some implementations, in response to the touch input shown in FIG. 3D, the touch input data included in the touch heat map 400D for the screen 240D may cause the processor 205 to enlarge the Buy Tickets link as illustrated in the screen 240D shown in FIG. 4B, allowing the user to confirm that the touch input was intended for the Buy Tickets link prior to proceeding with purchase, or to apply a corrected touch input. In this manner, the device 200 may continue to collect touch input data for the user that reflects not just touch inputs applied to a particular screen, but also touch input data related to an area of the screen at which the touch input was received, versus the area (icon, link, etc.) where the touch input was intended. This touch input data may be collected in the touch heat map for the screen, and may be used to further refine predictions based on the user's specific input habits, style and the like.

In this example, the touch heat map 400D shown in FIG. 4A provides a visual representation of user A's touch history associated with the information presented on the screen 240D. The touch heat map 400D is not necessarily displayed to the user A, but may provide a collection tool for touch input data related to user A's interaction with screen 240D. In the example touch heat map 400D, first areas 410, shown in a first cross hatch pattern in FIG. 4A, may correspond to areas of the screen 240D that are most frequently touched by user A. Second areas 420, shown in a dotted pattern in FIG. 4A, may correspond to areas of the screen 240D that are touched by user A less frequently than the first areas 410. Third areas 430, shown in a second cross hatch pattern in FIG. 4A, may correspond to areas of the screen 240D that are touched by user A less frequently than the second areas 420. Other areas or portions of the touch heat map 400D not covered by one of the first, second or third areas, may indicate infrequent touches, or a lack of touches, applied to those portions of the screen 240D.

In the example implementation shown in FIGS. 3A-3D and 4A-4B, the touch heat map 400D includes identification of three touch input areas 410, 420 and 430 to which user A most frequently directs touch inputs on screen 240D. However, in some implementations, the touch heat map 400D may collect and identify more, or fewer, touch input areas, depending, for example, on the touch input data collected, the type of information presented on the particular screen, a size of the touchscreen display on which the particular screen is to be displayed, and other such factors. As additional touch input data for the screen 240D is collected, the touch heat map 400D may be updated to reflect more current usage of and selection from the screen 240D by the user A.

In some implementations, the ordering, or grouping, of touch input data in the touch heat map 400D, in determining and representing the first area(s) 410, second area(s) 420 and third area(s) on the touch heat map 400D, may be established based on relative thresholds. For example, a number of touch inputs in one area of the screen, expressed as a percentage of total touch inputs received on the screen, exceeding a first threshold may designate that area as one of first area(s) 410, most frequently touched, or corresponding to items most frequently selected by the user A. Similar approaches may applied in designating other areas of the screen. Other approaches may be taken in collecting and representing touch input data in the touch heat map 400D.

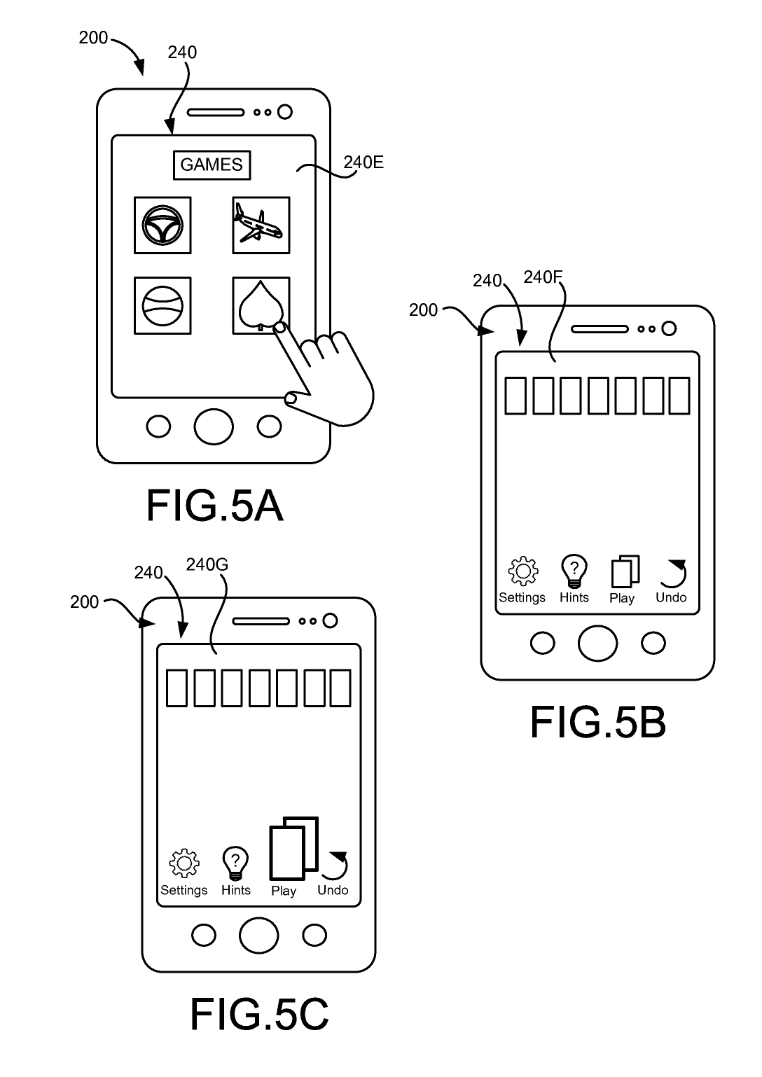

In some implementations, touch input data included in a touch heat map may be used to clarify, or confirm, a user's intended selection of an item from a particular screen. For example, as shown in FIG. 5A, a user may select a card game from a Game screen 240E, and in response to the selection, an initial card game screen 240F may be displayed, as shown in FIG. 5B. In the example screen 240F shown in FIG. 5B, a plurality of icons, including a Settings icon, a Hints icon, a Play icon and an Undo icon, are displayed along a lower edge portion of the screen 240F. Due, at least in part, to the relatively small size and relatively close placement of the icons long the lower edge portion of the screen 240F, a user touch input to select one of these icons may be misplaced, or not entirely placed on the intended icon, or may overlap with another, unintended icon.

For example, as shown in FIG. 5B, the user may intend to apply a touch input to the Play icon, to initiate a game and deal the cards. However, due to the relatively small size and close proximity of the Play icon and the Undo icon, the user's touch input may inadvertently overlap the Play icon and the Undo icon. In this instance, because the device 200 has access to a touch heat map associated with the user's interaction with screen 240F, the device 200 may refer to touch input information included in the touch heat map to discriminate the user's intended selection.

For example, in some implementations, in response to the touch input shown in FIG. 5B, the touch input data included in the touch heat map for the screen 240F may cause the processor 205 to predict that it was the user's intention to select the Play icon, and deal a set of cards to initiate play, without further confirmation from the user to initiate play. In some implementations, this determination may be made by the processor 205 based on a frequency at which the user selects the Play icon, based on data collected, for example, in the touch heat map, right after launching the Card game application.

In some implementations, in response to the touch input shown in FIG. 5B, the touch input data included in the touch heat map for the screen 240F may cause the processor 205 to enlarge the Play icon as illustrated in the screen 240G shown in FIG. 5C, allowing the user to confirm that the touch input was intended for the Play icon prior to proceeding with play, or to apply a corrected touch input. In this manner, the device 200 may continue to collect touch input data for the user that reflects not just touch inputs applied to a particular screen, but also touch input data related to an area of the screen at which the touch input was received, versus the area (icon, link, etc.) where the touch input was intended. This touch input data may be collected in the touch heat map for the screen, and may be used to further refine predictions based on the user's specific input habits, style and the like.

In some implementations, the device 200 may determine, based on data collected, for example, in the touch heat map, that the Play icon is most frequently selected by the user right after launching the Card game application, and may automatically enlarge the Play icon and display the screen 240G shown in FIG. 5C, including the enlarged Play icon, in response to selection of the Card game from the screen 240E shown in FIG. 5A, and prior to receiving a touch input to select one of the icons, as shown in FIG. 5C.

In some implementations, touch heat maps, in accordance with implementations as described herein, may also be used to predict and refine user intention with touch and drag inputs on a touch sensitive surface of a touchscreen display device in a similar manner.

In some implementations, touch input data included in the touch heat maps generated by the device 200 may be periodically provided back to application developers to improve user interfaces of the applications, and user interaction with the user interfaces.

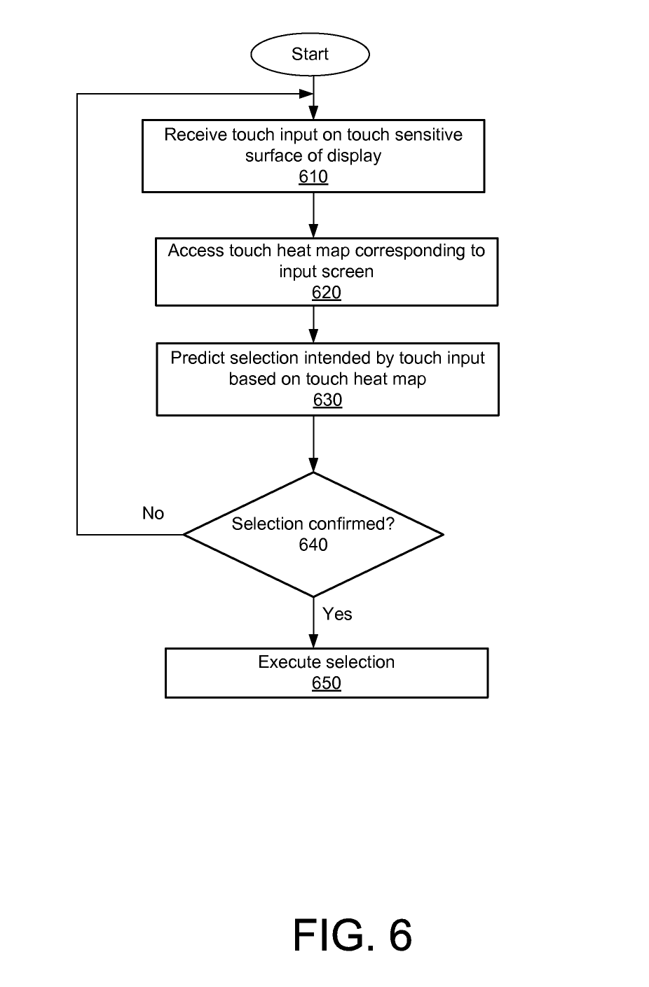

FIG. 6 is a flowchart of an exemplary method of operating an electronic computing device, such as, for example, one of the electronic computing devices 100, 150, 190 shown in FIGS. 1A-1D and/or the electronic computing device shown in FIG. 2, configured to access a touch heat map to predict and/or refine user inputs on a touch sensitive surface of a touchscreen display of the device, in accordance with implementations as described herein.

As shown in FIG. 6, when the device is operational, the device may, at block 610, receive a touch input on a touch sensitive surface of a touchscreen display of the device. The touch input may be, for example, selection of a link or icon, as discussed above with respect to FIGS. 3A-3D and 5A-5C. In response to receiving the touch input at block 610, the device may, at block 620, access a touch heat map corresponding to an input screen displayed by the touchscreen display and associated with the received touch input. The device may then, at block 630, use touch input data collected in the touch heat map to predict a selection intended by the received touch input.

In particular, in some implementations, the device may use the touch input data collected in the touch heat map to predict an item (a link, and icon and the like) that the user is likely to select on a screen to be displayed based on the received touch input. For example, in some implementations, the device may use the touch input data collected in the touch heat map to predict a link or icon the user is likely to select, and then enlarge the predicted link or icon when displaying the corresponding input screen, as shown in FIGS. 4B and 5C, to facilitate the user's accurate selection of that link or icon. In some implementations, the device may use the touch input data collected in the touch heat map to predict a link or icon intended for selection when the touch input inadvertently covers more than one link or icon that could be selected, as shown in FIG. 5B.

Once selection of the item is confirmed, at block 640, the device may execute the selection, at block 650. In some implementations, confirmation of selection of the item may include, for example, a touch input received at an area of the touch sensitive surface of the touchscreen display corresponding to the enlarged link or icon. In some implementations, confirmation may include, for example, a confirmation by the device, based on the touch input data included in the touch heat map, to proceed with execution of the selected item. This may also include, for example, a confirmation that a touch input has not been received from the user reverting to a previous screen to reverse the predicted selection.

An electronic device, and a method of operating an electronic device, in accordance with implementations as described herein, may use touch heat map(s) of user interactions with different applications of the electronic device and associated user profile(s) to predict user selections intended by user touch inputs on a touch sensitive surface of a touchscreen display of the device. This may enhance user convenience of the device, and utility and functionality provided to the user by the device.

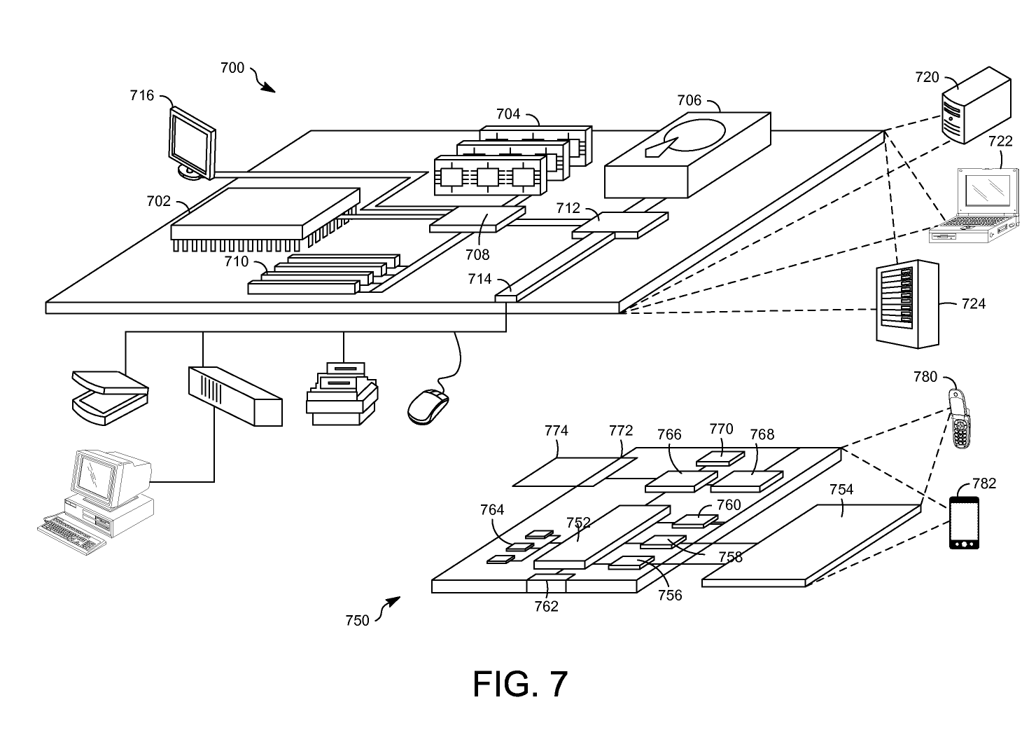

FIG. 7 shows an example of a generic computing device 700 and a generic mobile computing device 780, similar to the computing devices 100, 150 and 190 shown in FIGS. 1A-1D, respectively, illustrating some of the components of the respective computing devices. Computing device 700 is intended to represent various forms of digital computers, such as laptop computers, convertible computers, tablet computers, desktop computers, workstations, personal digital assistants, servers, blade servers, mainframes, and other appropriate computers. Computing device 780 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 800, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 780. Each of such devices may contain one or more of computing device 700, 780, and an entire system may be made up of multiple computing devices 700, 780 communicating with each other.

Computing device 780 includes a processor 782, memory 764, and an input/output device such as a display 784, a communication interface 766, and a transceiver 768, among other components. The device 780 may also be provided with a storage device, such as a microdrive or other device, to provide additional storage. Each of the components 780, 782, 764, 784, 766, and 768, are interconnected using various buses, and several of the components may be mounted on a common motherboard or in other manners as appropriate.

The processor 782 can execute instructions within the computing device 780, including instructions stored in the memory 764. The processor may be implemented as a chipset of chips that include separate and multiple analog and digital processors. The processor may provide, for example, for coordination of the other components of the device 780, such as control of user interfaces, applications run by device 780, and wireless communication by device 780.

Processor 782 may communicate with a user through control interface 788 and display interface 786 coupled to a display 784. The display 784 may be, for example, a TFT LCD (Thin-Film-Transistor Liquid Crystal Display) or an OLED (Organic Light Emitting Diode) display, or other appropriate display technology. The display interface 786 may comprise appropriate circuitry for driving the display 784 to present graphical and other information to a user. The control interface 788 may receive commands from a user and convert them for submission to the processor 782. For example, the control interface 788 may receive in input entered by a user via, for example, the keyboard 780, and transmit the input to the processor 782 for processing, such as, for entry of corresponding text into a displayed text box. In addition, an external interface 762 may be provide in communication with processor 782, so as to enable near area communication of device 780 with other devices. External interface 762 may provide, for example, for wired communication in some implementations, or for wireless communication in other implementations, and multiple interfaces may also be used.

The memory 764 stores information within the computing device 780. The memory 764 can be implemented as one or more of a computer-readable medium or media, a volatile memory unit or units, or a non-volatile memory unit or units. Expansion memory 774 may also be provided and connected to device 880 through expansion interface 772, which may include, for example, a SIMM (Single In Line Memory Module) card interface. Such expansion memory 774 may provide extra storage space for device 780, or may also store applications or other information for device 780. Specifically, expansion memory 774 may include instructions to carry out or supplement the processes described above, and may include secure information also. Thus, for example, expansion memory 774 may be provide as a security module for device 880, and may be programmed with instructions that permit secure use of device 880. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 874, or memory on processor 782, that may be received, for example, over transceiver 768 or external interface 762.

Device 780 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 780, which may be used as appropriate by applications running on device 780.

Device 780 may also communicate audibly using audio codec 760, which may receive spoken information from a user and convert it to usable digital information. Audio codec 760 may likewise generate audible sound for a user, such as through a speaker, e.g., in a handset of device 780. Such sound may include sound from voice telephone calls, may include recorded sound (e.g., voice messages, music files, etc.) and may also include sound generated by applications operating on device 780.

The computing device 780 may be implemented in a number of different forms, as shown in the figure. For example, it may be implemented as a cellular telephone 780. It may also be implemented as part of a smart phone 782, personal digital assistant, or other similar mobile device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium), for processing by, or to control the operation of, data processing apparatus, e.g., a programmable processor, a computer, or multiple computers. Thus, a computer-readable storage medium can be configured to store instructions that when executed cause a processor (e.g., a processor at a host device, a processor at a client device) to perform a process. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), a light emitting diode (LED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.”

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method of operating a device, comprising:
displaying a plurality of items on display area of a touchscreen of the device;
generating a user specific touch heat map based on a plurality of touch and release inputs received from the user on the touchscreen on which the graphical user interface is displayed, the touch heat map being associated with an executable application of the device, and storing the touch heat map in a memory;
executing the application;
accessing the stored touch heat map from the memory;
receiving a first touch input on the touchscreen; and
displaying a graphical user interface having an appearance tailored for the user based on the stored touch heat map and a touch input history provided by the touch heat map.

2. The method of claim 1, wherein displaying a graphical user interface tailored for the user includes:
predicting a second touch input on the touchscreen based on the first touch input and the touch input history provided by the touch heat map; and
altering an appearance of one item of the plurality of items displayed on the display area of the touchscreen for selection.

3. The method of claim 2, further comprising, in response to the prediction of the second touch input,
determining that a probability that the second touch input includes the one item is higher than a probability that the second touch input includes any other item of the plurality of items.

4. The method of claim 3, further comprising:
associating the touch input history provided by the user specific touch heat map with a specific user to define a user profile for the user of the application; and
associating the user profile with an input interface of the application.

5. The method of claim 4, wherein the application includes a plurality of input interfaces corresponding to a plurality of input screens displayed on the touchscreen, and further comprising generating a touch heat map and an associated user profile for each of the plurality of input interfaces and corresponding input screens of the application.

6. The method of claim 2, wherein altering an appearance one item of the plurality of items includes enlarging the one item of the plurality of items displayed on the touchscreen, or highlighting the one item of the plurality of items displayed on the touchscreen.

7. The method of claim 6, further comprising maintaining a size and appearance of items of the plurality of items, other than the one item having an altered appearance, while the display of the one item of the plurality of items is altered.

8. The method of claim 2, wherein receiving a first touch input on the touchscreen includes:
receiving the first touch input on an area of the touchscreen that contacts both a first item and a second item.

9. The method of claim 8, wherein predicting a second touch input based on the first touch input and the touch input history provided by the touch heat map includes:
predicting, based on the touch input history provided by the touch heat map, an intended touch area corresponding to one of the first item or the second item; and
executing a component of the application associated with the one of the first item or the second item based on the prediction.

10. The method of claim 9, further comprising:
enlarging a display of the one of the first item or the second item based on the prediction; and
executing the component associated with the one of the first item or the second item in response to the second touch input, the second touch input being received in an area of the touchscreen corresponding to the enlarged display of the one of the first item or the second item.

11. The method of claim 1, further comprising:
collecting a plurality of additional touch and release inputs from the user on the touchscreen, the plurality of additional touch inputs being associated with the application;
updating the user specific touch heat map based on the plurality of additional touch inputs; and
storing the updated touch heat map.

12. A method, comprising:
receiving, on a touchscreen of an electronic computing device, a first touch input;
accessing, in response to a release of the first touch input, a user specific touch heat map, the touch heat map including touch input data for the user corresponding to an input interface associated with the received first touch input;
predicting a selection to be made by the user from a plurality of items available via the input interface based on the touch input data for the user included in the user specific touch heat map; and
displaying a user input interface for the user based on the prediction.

13. The method of claim 12, wherein predicting a selection for the user of an item of a plurality of items available via the user input interface based on the touch input data for the user included in the touch heat map includes:
defining a touch input history for the user input interface and an associated user profile for the user of the user input interface based on the touch input data included in the touch heat map; and
determining that a probability that the selection to be made by the user includes an item of the plurality of items available via the user input interface is higher that a probability that the selection to be made by the user includes any other of the plurality of items based on the touch input history and the associated user profile.

14. The method of claim 13, wherein displaying a user input interface for the user based on the prediction includes:
enlarging a display size of the determined item of the plurality of items in the user input interface; and
executing a component of the application associated with the item in response to a second touch input, the second touch input being received in an area of the touchscreen corresponding to the enlarged display of the item.

15. The method of claim 12, wherein receiving a first touch input includes:
receiving the first touch input on an area of the touchscreen that contacts both a first item and a second item of the plurality of items included in the user input interface.

16. The method of claim 15, wherein predicting a selection to be made by the user from a plurality of items available via the user input interface based on the touch input data for the user included in the touch heat map includes:
predicting, based on a touch input history and corresponding user profile provided by the touch heat map, an intended touch area corresponding to one of the first item or the second item; and
executing a component of an application associated the one of the first item or the second item based on the prediction.

17. The method of claim 16, further comprising:
enlarging a display of the one of the first item or the second item based on the prediction; and
executing the component of the application associated with the one of the first item or the second item in response to a second touch input, the second touch input being received in an area of the touchscreen corresponding to the enlarged display of the one of the first item or the second item.

18. An electronic computing device, including:
a display device including a touchscreen having a touch sensitive surface;
a memory storing executable instructions; and
a processor configured to execute the instructions to cause the electronic computing device to:
generate a touch heat map based on a plurality of touch inputs received on the touch sensitive surface of the touchscreen, the touch heat map being associated with a user and an application executable by the device;
store the touch heat map in the memory;
execute the application in response to a first touch input on the touch sensitive surface of the touchscreen and a release of the first touch input; and
predict a second touch input based on the first touch input and a touch input history for the user in the application provided by the touch heat map.

19. The device of claim 18, the instructions also causing the electronic computing device to:
determine that a probability that the second touch input includes one item of a plurality of items displayed in a display area of the touchscreen is higher than a probability that the second touch input includes any other item of the plurality of items; and
enlarge a display of the one item in a display area of the of the touchscreen.

20. The device of claim 18, wherein the first touch input contacts both a first item and a second item of a plurality of items displayed in a display area of the touchscreen, the instructions also causing the electronic computing device to:
predict, based on the touch input history for the user provided by the touch heat map, an intended touch area corresponding to one of the first item or the second item; and
execute a component of an application associated with the one of the first item or the second item based on the prediction.
